(19) United States
(12) Patent Application Publication
(10) Pub. No.: US 2024/0021832 A1
(43) Pub. Date: Jan. 18, 2024

(54) ELECTROCHEMICAL DEVICE AND ELECTRONIC DEVICE

(71) Applicant: Ningde Amperex Technology Limited, Ningde (CN)

(72) Inventor: Xiaohu CAI, Ningde (CN)

(73) Assignee: Ningde Amperex Technology Limited, Ningde (CN)

(21) Appl. No.: 18/476,885

(22) Filed: Sep. 28, 2023

Related U.S. Application Data
(63) Continuation of application No. PCT/CN2021/084053, filed on Mar. 30, 2021.

(51) Int. Cl. H01M 4/62; H01M 4/131; H01M 4/525; H01M 10/0525

(52) U.S. Cl. CPC H01M 4/623; H01M 4/131; H01M 4/525; H01M 10/0525; H01M 2004/028

(57) ABSTRACT

A positive electrode includes a current collector and a positive electrode mixture layer provided on at least one surface of the current collector, the current collector includes a first region and a second region, the first region is coated with the positive electrode mixture layer, the second region is a foil-free region of the positive electrode, the positive electrode mixture layer includes a positive electrode active material and a binder, and a roughness Sa₁ of a surface of a current collector of the first region and a roughness Sa₂ of a surface of a current collector of the second region satisfy: 1≤Sa₁/Sa₂≤20. The positive electrode of the present application has a high compacted density and toughness, thereby improving the problem of brittle fracture of the positive electrode and improving the rate capability of a lithium-ion battery.

### CROSS REFERENCE TO THE RELATED APPLICATIONS

This application is a continuation under 35 U.S.C. § 120 of international patent application PCT/CN2021/084053 filed on Mar. 30, 2021, the entire content of which is incorporated herein by reference.

### TECHNICAL FIELD

The present application relates to the field of electrochemical technology, and in particular to an electrochemical device and an electronic device.

### BACKGROUND

Lithium-ion batteries are widely used in various fields such as electric energy storage, portable electronic equipment and electric vehicles due to their characteristics such as high specific energy, high operating voltage, low self-discharge rate, small size and light weight.

With the development of lithium-ion battery industry, the demand for dynamic performance and energy density of lithium-ion batteries is also increasing. One of the methods to increase the energy density of lithium-ion batteries is to increase the compacted density of the positive electrode. However, when the compacted density of the positive electrode is high (e.g., higher than 3.0 g/mm3), the active material particles are easy to embed in the current collector during the cold pressing process, causing damage to the current collector and being prone to brittle fracture of the positive electrode, resulting in the loss of performance of lithium-ion batteries.

### SUMMARY

An object of the present application is to provide an electrochemical device and an electronic device, so as to improve the toughness of a positive electrode having a high compacted density and the rate capability of a lithium-ion battery. The specific technical solutions are as follows:

It is to be noted that, in the content of the present application, the present application is explained by an example using a lithium-ion battery as an electrochemical device, but the electrochemical device of the present application is not limited to the lithium-ion battery.

A first aspect of the present application provides an electrochemical device including a positive electrode including a current collector and a positive electrode mixture layer provided on at least one surface of the current collector, the current collector including a first region and a second region, the first region being coated with a positive electrode mixture layer, the second region being a foil-free region of the positive electrode, the positive electrode mixture layer including a positive electrode active material and a binder, wherein a roughness Sa1 of a surface of a current collector of the first region and a roughness Sa2 of a surface of a current collector of the second region satisfy: 1≤Sa1/Sa2≤20, preferably 10≤Sa1/Sa2≤14.

As a whole, the roughness Sa1 of the surface of the current collector of the first region and the roughness Sa2 of the surface of the current collector of the second region in the current collector of the present application satisfy: 1≤Sa1/Sa2≤20. Without being limited to any theory, the roughness of the surface of the current collector of the first region and the second region is within the above range, the damage to the current collector by the positive electrode active material is reduced, the flexibility of the positive electrode is improved, and the problem of brittle fracture of the positive electrode at high compacted density is solved.

In the present application, the first region may refer to a region where the current collector is coated with a positive electrode mixture layer, and the second region may refer to a foil-free region of the positive electrode. The foil-free region refers to a region in the positive electrode which is not coated with the positive electrode mixture layer, and the foil-free region is generally located at the initial end and the final end of the positive electrode of the lithium-ion battery in a wound structure.

The positive electrode mixture layer of the present application may be provided on at least one surface of the current collector, for example, the positive electrode mixture layer may be provided on one surface of the current collector, or the positive electrode mixture layer may be provided on both surfaces of the current collector. In the present application, the positive electrode may specifically refer to a positive electrode plate, and the negative electrode may specifically refer to a negative electrode plate.

In an embodiment of the present application, a strength P1 of the current collector in the first region and a strength P2 of the current collector in the second region satisfy: 0%≤(P2−P1)/P2≤22%. Without being limited to any theory, when (P2−P1)/P2 is excessively large (e.g., greater than 22%), it indicates that the rate of decrease in the strength of the current collector in the first region is excessively large, and the current collector in the first region is prone to brittle fracture. By controlling (P2−P1)/P2 within the above range, the flexibility of the positive electrode can be further improved.

In an embodiment of this application, the positive electrode mixture layer has a compacted density of 3.0 g/mm3 to 4.5 g/mm3, preferably 4.0 g/mm3 to 4.3 g/mm3. Without being limited to any theory, when the compacted density of the positive electrode mixture layer is too low (e.g., less than 3.0 g/mm3), it is not conducive to the improvement of rate performance of the lithium-ion battery; when the compacted density of the positive electrode mixture layer is too high (e.g., higher than 4.5 g/mm3), the active material particles are easily embedded into the current collector after cold pressing, causing damage to the current collector and being prone brittle fracture of the positive electrode. By controlling the compacted density of the positive electrode mixture layer within the above range, the rate performance of the lithium-ion battery can be further improved while the flexibility of the positive electrode can be further improved.

In an embodiment of the present application, a weight average molecular weight of the binder is 1000000 to 1400000. Without being limited to any theory, a weight average molecular weight of the binder is too low (e.g., less than 1000000), it makes the binder softer, resulting in a decrease in the softening point of the binder, which is detrimental to the improvement of the binding performance of the binder; when the weight average molecular weight of the binder is too high (e.g., higher than 1400000), the softening point of the binder is too high, which is detrimental to processing and also detrimental to the improvement of the binding performance of the binder. By controlling the weight average molecular weight of the binder of the present application within the above range, the binder with good binding performance can be obtained, thereby improving the cycle stability of the lithium-ion battery.

In an embodiment of the present application, molecular weight distribution of the binder satisfies: 1.9≤Mw/Mn≤2.5, in which Mw represents a weight average molecular weight and Mn represents a number average molecular weight. Without being limited to any theory, when the Mw/Mn is too large (e.g., greater than 2.5), it means that the molecular weight distribution of the binder is relatively wide, in particular, the molecular weight of a macromolecular binder is too large and the molecular weight of a small molecule binder is too small, while the macromolecular binder is not easy to melt after being heated, and the small molecule binder is easy to agglomerate in a slurry, which is detrimental to the improvement of the binding performance of the binder as a whole; when the Mw/Mn is too small (e.g., less than 1.9), the molecular weight distribution is narrow, during the cold pressing process, the strong binding action of the macromolecular part in the binder leads to large interparticle force, resulting in a failure of effective slip, and the current collector is severely damaged under high compacted density, leading to brittle fracture of the electrode plate. By controlling the molecular weight distribution of the binder of the present application within the above range, the binding performance of the binder can be further improved and the production cost of the binder can be reduced.

In an embodiment of the present application, the binder has a swelling ratio of 15% to 25% after being soaked in an electrolytic solution at 85° C. for 6 hours, indicating that the binder of the present application has excellent electrolytic solution swelling resistance. Without being limited to any theory, when the swelling rate of the binder is too high (e.g., higher than 25%), the swelling of the positive electrode will be increased, leading to an increase in swelling of the lithium-ion battery during use, affecting the safety of the lithium-ion battery; when the swelling ratio of the binder is too low (e.g., less than 15%), it makes the porosity of the positive electrode mixture layer lower, and the ionic conduction and electronic conduction of the positive electrode are affected.

In an embodiment of the present application, the binder includes polyvinylidene fluoride (PVDF). Without being limited to any theory, the binder includes PVDF, and by controlling the molecular weight distribution thereof, the small molecular weight PVDF chain segment therein can ensure effective slip between particles, further improving the compacted density of the positive electrode mixture layer and the flexibility of the positive electrode; and the large molecular weight PVDF chain segment can suspend the positive electrode active material, a conductive agent, etc. in the slurry when the slurry is prepared, so as to maintain the stability of the slurry.

In an embodiment of the present application, an adhesion force between the positive electrode mixture layer and the current collector is 15 N/m to 35 N/m, preferably 18 N/m to 25 N/m. Without being limited to any theory, when the adhesion force between the positive electrode mixture layer and the current collector is too low (e.g., less than 15 N/m), it is unfavorable for the improvement of the structural stability and flexibility of the positive electrode; when the adhesion force between the positive electrode mixture layer and the current collector is too high (e.g., higher than 35 N/m), it is necessary to use more binders, which is disadvantageous for improving the energy density of the lithium-ion battery. By controlling the adhesion force between the positive electrode mixture layer and the current collector of the present invention within the above range, the flexibility of the positive electrode and the energy density of the lithium-ion battery can be further improved.

In an embodiment of the present application, a Dv50 of the positive electrode active material is 0.5 μm to 35 μm, preferably 5 μm to 30 μm, more preferably 10 μm to 25 μm. Without being limited to any theory, when the Dv50 of the positive electrode active material is too small (e.g., less than 0.5 μm), the positive electrode active material particles accumulate poorly with the binder and conductive agent particles in the positive electrode mixture layer, the compacted density of the positive electrode mixture layer decreases, and the cold pressing pressure needs to be increased to enhance the compacted density, which further increases the brittleness of the positive electrode; when the Dv50 of the positive electrode active material is too large (e.g., greater than 35 μm), since the positive electrode active material particles have a larger particle size and more edges and corners, the damage to the current collector during the cold pressing process increases, and the brittleness of the positive electrode under high compacted density is also made high. By controlling the Dv50 of the positive electrode active material of the present application within the above range, the compacted density of the positive electrode mixture layer and the flexibility of the positive electrode can be further improved.

Dv50 represents a particle size at which a particle reaches 50% of a cumulative volume from a small particle size side in the particle size distribution on a volume basis.

In an embodiment of the present application, a relationship between Dv10 and Dv50 of the positive electrode active material satisfies: 0.25≤Dv10/Dv50≤0.5, preferably 0.33≤Dv10/Dv50≤0.45. Without being limited to any theory, when Dv10/Dv50 is too small (e.g., less than 0.25), there are many small particle size particles in the positive electrode active material, and the active particles of the positive electrode active material accumulate poorly with the binder and conductive agent particles in the positive electrode mixture layer, which is not conducive to improving the flexibility of the positive electrode; when Dv10/Dv50 is too large (e.g., greater than 0.5), there are more particles with large particle size in the positive electrode active material, and the damage to the current collector during cold pressing increases, and the flexibility of the electrode plate under high compacted density is also made poor. By controlling the Dv10 and Dv50 of the positive electrode active material of the present application within the above range, the compacted density of the positive electrode mixture layer and the flexibility of the positive electrode can be further improved.

Dv10 represents a particle size at which a particle reaches 10% of a cumulative volume from a small particle size side in the particle size distribution on a volume basis.

In an embodiment of the present application, a single-sided thickness of the positive electrode mixture layer is 40.5 μm to 55 μm. Without being limited to any theory, when the thickness of the positive electrode mixture layer is too low (e.g., less than 40.5 μm), the active material particles in the positive electrode mixture layer are easily broken during cold pressing, which affects the cycle performance of the lithium-ion battery, and at the same time, the active material with large particles damages the current collector more seriously, so that the electrode plate is more prone to brittle fracture during winding, which is not conducive to improving the compacted density of the electrode plate; when the thickness of the positive electrode mixture layer is too high (e.g., higher than 55 μm), stress concentration resulting in brittle fracture is more likely to occur when the positive electrode sheet is folded in half. By controlling the single sided thickness of the positive electrode mixture layer of the present application within the above-mentioned range, the flexibility of the positive electrode and the compacted density of the positive electrode mixture layer can be further improved, thereby improving the performance of the lithium-ion battery.

In an embodiment of the present application, a thickness of the current collector of the positive electrode is 7 μm to 20 μm, preferably 9 μm to 12 μm. Without being limited to any theory, when the thickness of the current collector is too low (e.g., less than 7 μm), it is not favorable to increase the strength of the positive electrode; when the thickness of the current collector is too high (e.g., more than 20 μm), it is disadvantageous to improve the energy density of the lithium-ion battery. By controlling the thickness of the current collector of the positive electrode within the above range, the strength of the positive electrode and the energy density of the lithium-ion battery can be further improved.

The content of the binder in the positive electrode mixture layer is not particularly limited in the present application as long as the requirements of the present application are met, and in an embodiment, the mass percentage content of the binder in the positive electrode mixture layer is 1% to 5%.

A preparation method for the binder of the present application is not particularly limited, and a preparation method of a person skilled in the art can be used, for example, the following preparation method can be used:

A reaction kettle is vacuumized, nitrogen is drawn to replace oxygen, deionized water, a sodium perfluorooctanoate solution with a mass concentration of about 5% and paraffin (melting point 60° C.) are put into the reaction kettle, the stirring speed is adjusted to 120 rpm/min to 150 rpm/min, the temperature of the reaction kettle is raised to about 90° C., and vinylidene fluoride monomer is added until the kettle pressure is 5.0 MPa. An initiator is added to start a polymerization reaction and additional vinylidene fluoride monomer is added to maintain the kettle pressure at 5.0 MPa. Additional 0.005 g to 0.01 g of the initiator may be added at about 10 min intervals in batches, and at 20%, 40%, 60% and 80% conversion rate, a chain transfer agent may be additionally added in four batches, with 3 g to 6 g each batch. When the reaction proceeds until the pressure drops to 4.0 MPa, the material is collected by venting, and the reaction time is 2 hours to 3 hours.

The initiator is not particularly limited in the present application as long as it can initiate polymerization of the monomer, and may be, for example, dioctyl peroxydicarbonate, or phenoxyethyl peroxydicarbonate, etc. The addition amount of deionized water, initiator and chain transfer agent is not particularly limited in the present application as long as the polymerization reaction of the added monomers is ensured.

The positive electrode current collector in the positive electrode of the present application is not particularly limited, and may be any positive electrode current collector in the art, for example, an aluminum foil, an aluminum alloy foil, or a composite current collector, etc. The positive electrode active material layer includes a positive electrode active material and a conductive agent, and the positive electrode active material is not particularly limited, and may be any positive electrode active material in the art, for example, it may include at least one of lithium nickel cobalt manganate (811, 622, 523, 111), lithium nickel cobalt aluminate, lithium iron phosphate, a lithium-rich manganese-based material, lithium cobaltate, lithium manganate, lithium iron manganese phosphate, or lithium titanate. The conductive agent is not particularly limited as long as the object of the present application can be achieved. For example, the conductive agent may include at least one of conductive carbon black (Super P), carbon nanotube (CNTs), carbon nanofiber, flake graphite, acetylene black, carbon black, Ketjen black, carbon dots, graphene, or the like.

The negative electrode plate in the present application is not particularly limited as long as the object of the present application can be achieved. For example, the negative electrode plate generally includes a negative electrode current collector and a negative electrode active material layer. The negative electrode current collector is not particularly limited, and may be any negative electrode current collector in the art, for example, copper foil, aluminum foil, copper alloy foil, a composite current collector, and the like. The negative electrode active material layer includes a negative electrode active material, and the negative electrode active material is not particularly limited, and may be any negative electrode active material in the art. For example, the negative electrode active material may include at least one of artificial graphite, natural graphite, mesocarbon microbeads, soft carbon, hard carbon, silicon, silicon carbon, lithium titanate, and the like.

A separator of the present application includes, but is not limited to, at least one selected from polyethylene, polypropylene, polyethylene terephthalate, polyimide, or aramid. For example, the polyethylene includes at least one component selected from high-density polyethylene, low-density polyethylene and ultra-high molecular weight polyethylene. Particularly, the polyethylene and the polypropylene have a good effect on preventing short circuits, and can improve the stability of the lithium-ion battery by a shutdown effect.

The surface of the separator may further include a porous layer disposed on at least one surface of the separator, the porous layer including inorganic particles and a binder, the inorganic particles being selected from one or a combination of more of aluminum oxide (Al2O3), silicon oxide (SiO2), magnesium oxide (MgO), titanium oxide (TiO2), hafnium oxide (HfO2), tin oxide (SnO2), cerium oxide (CeO2), nickel oxide (NiO), zinc oxide (ZnO), calcium oxide (CaO), zirconium oxide (ZrO2), yttrium oxide (Y2O3), silicon carbide (SiC), boehmite, aluminum hydroxide, magnesium hydroxide, calcium hydroxide, and barium sulfate. The binder is selected from one or a combination of more of polyvinylidene fluoride, vinylidene fluoride-hexafluoropropylene copolymer, polyamide, polyacrylonitrile, polyacrylate, polyacrylic acid, polyacrylate, sodium carboxymethyl cellulose, polyvinyl pyrrolidone, polyvinyl ether, polymethyl methacrylate, polytetrafluoro ethylene, and polyhexafluoropropylene.

The porous layer can improve the heat resistance, oxidation resistance and electrolytic solution wetting property of the separator, and enhance the binding performance between the separator and the positive electrode or negative electrode.

The lithium-ion battery of the present application further includes an electrolyte which may be one or more of a gel electrolyte, a solid electrolyte and an electrolytic solution including a lithium salt and a non-aqueous solvent.

In some embodiments of the present application, the lithium salt is selected from one or more of LiPF6, LiBF4, LiAsF6, LiClO4, LiB(C6H5)4, LiCH3SO3, LiCF3SO3, LiN(SO2CF3)2, LiC(SO2CF3)3, LiSiF6, LiBOB, and lithium difluoroborate. For example, LiPF6 can be selected as the lithium salt because it can provide high ionic conductivity and improve cycle characteristics.

The non-aqueous solvent may be a carbonate compound, a carboxylic ester compound, an ether compound, other organic solvents, or combinations thereof

The above carbonate compound may be a chain carbonate compound, a cyclic carbonate compound, a fluorocarbonate compound, or a combination thereof

Examples of the above chain carbonate compounds are dimethyl carbonate (DMC), diethyl carbonate (DEC), dipropyl carbonate (DPC), methyl propyl carbonate (MPC), ethyl propyl carbonate (EPC), methyl ethyl carbonate (MEC), and a combination thereof. Examples of the cyclic carbonate compound are ethylene carbonate (EC), propylene carbonate (PC), butylene carbonate (BC), vinyl ethylene carbonate (VEC) and a combination thereof. Examples of the fluorocarbonate compound are fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene carbonate, and a combination thereof.

Examples of the above carboxylate compound are methyl formate, methyl acetate, ethyl acetate, n-propyl acetate, t-butyl acetate, methyl propionate, ethyl propionate, propyl propionate, γ-butyrolactone, decalactone, valerolactone, DL-Mevalonolac, caprolactone, and a combination thereof.

Examples of the above ether compound are dibutyl ether, tetraglyme, diglyme, 1,2-dimethoxyethane, 1,2-diethoxyethane, ethoxymethoxyethane, 2-methyl tetrahydrofuran, tetrahydrofuran, and a combination thereof.

Examples of the above other organic solvents are dimethyl sulfoxide, 1,2-dioxolane, sulfolane, methyl sulfolane, 1,3-dimethyl -2-imidazolidinone, N-methyl-2-pyrrolidone, formamide, dimethylformamide, acetonitrile, trimethyl phosphate, triethyl phosphate, trioctyl phosphate, and phosphate and a combination thereof.

A second aspect of the present application provides an electronic device including the above electrochemical device according to the first aspect.

The electronic device of the present application is not particularly limited and may be known any electronic device used in the prior art. In some embodiments, the electronic device may include, but is not limited to, a notebook computer, a pen-input computer, a mobile computer, an electronic book player, a portable phone, a portable fax machine, a portable copier, a portable printer, a headphone, a video recorder, a liquid crystal television, a hand-held cleaner, a portable CD machine, a mini disc, a transceiver, an electronic organizer, a calculator, a memory card, a portable audio recorder, a radio, a backup power supply, a motor, an automobile, a motorcycle, a power bicycle, a bicycle, a lighting appliance, a toy, a game machine, a clock, a power tool, a flash light, a camera, a large household storage battery, a lithium-ion capacitor, etc.

The preparation process of the electrochemical device is well known to a person skilled in the art, and is not particularly limited in the present application. For example, an electrochemical device can be manufactured by the following process: a positive electrode and a negative electrode are overlapped via a separator, and after operations such as winding and folding, the same are placed into a housing according to needs, and an electrolytic solution is injected into the housing and sealed, wherein the separator used is the above-mentioned separator provided by the present application. In addition, an overcurrent prevention element, a guide plate, or the like may also be placed in the housing as needed to prevent the pressure inside the electrochemical device from rising and overcharging and discharging.

The present application provides an electrochemical device and an electronic device, including a positive electrode including a current collector and a positive electrode mixture layer provided on at least one surface of the current collector, the current collector including a first region and a second region, wherein a roughness Sa1 of a surface of a current collector of the first region and a roughness Sa2 of a surface of a current collector of the second region satisfy: 1≤Sa1/Sa2≤20, so that the positive electrode mixture layer of the present application has a high compacted density, and the positive electrode has a high flexibility, thereby solving the problem of brittle fracture of the positive electrode and improving the rate performance of the lithium-ion battery.

### BRIEF DESCRIPTION OF DRAWINGS

In order that the technical solutions of the present application and the prior art may be more clearly illustrated, a brief description of drawings required in the embodiments and the prior art is set forth below. Obviously, the drawings in the following description are merely illustrative of some embodiments of the present application.

FIG. 1 is a schematic structural diagram of a positive electrode plate according to an embodiment of the present application;

FIG. 2 is a schematic structural diagram of a positive electrode plate according to another embodiment of the present application.

### DETAILED DESCRIPTION

The objects, technical solutions, and advantages of the present application will become more apparent from the following detailed description of the present application when taken in conjunction with the accompanying drawings and embodiments. Evidently, the described embodiments are only a few, but not all embodiments of the present application. All other embodiments obtained by a person skilled in the art on the basis of the present application are within the scope of protection of the present application.

It is to be noted that in the specific implementations of the present application, the present application is explained by an example using a lithium-ion battery as an electrochemical device, but the electrochemical device of the present application is not limited to the lithium-ion battery.

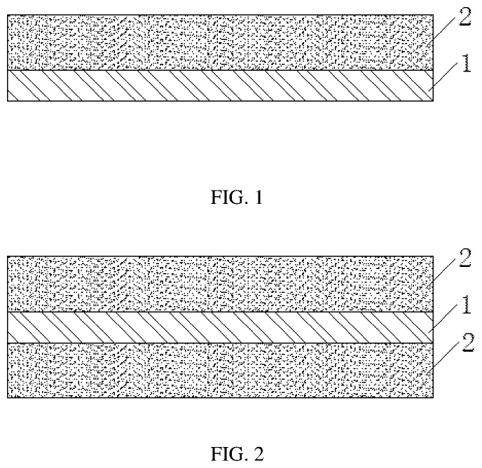

As shown in FIG. 1, in an embodiment of the present application, one of the surfaces of a current collector 1 in a positive electrode plate is provided with a positive electrode mixture layer 2.

As shown in FIG. 2, in an embodiment of the present application, both surfaces of a current collector 1 in a positive electrode plate are provided with a positive electrode mixture layer 2.

### EMBODIMENTS

Hereinafter, embodiments and comparative embodiments are given to more specifically describe the implementations of the present application. Various tests and evaluations were performed as follows. In addition, “parts” and “%” are on a mass basis unless otherwise specified.

### Test Methods and Equipment

Test for Adhesion Force Between Positive Electrode Mixture Layer and Current Collector
(1) A discharged lithium-ion battery to be tested was disassembled, then a positive electrode plate was taken out, soaked in DMO (dimethyl oxalate) for 30 min to remove an electrolytic solution and by-products on the surface of the positive electrode plate, and then dried in a fume hood at 25° C. for 4 hours, the dried positive electrode plate was taken out, and from same, a sample with a width of 30 mm and a length of 100 mm was cut;
(2) A double-sided adhesive tape was applied to a steel plate, the width of the double-sided adhesive tape being 20 mm and the length thereof being 90 mm;
(3) The sample cut in step (1) was pasted on the double-sided adhesive tape, and a test surface faces down and was adhered with the double-sided adhesive tape;
(4) A paper tape having a width equal to that of the sample and a length greater than 80 mm of the length of the sample was inserted under the sample and fixed with a crepe paper tape;
(5) A power supply of a tensile machine (brand is Sanshi, model is Instron 3365) was turned on, an indicator light was turned on, and a limit block was adjusted to an appropriate position;
(6) The sample prepared in (4) was fixed on a test bench, the paper tape was folded upwards and fixed with a clamp, the paper tape was pulled at a speed of 10 mm/min, with a test range was 0 mm to 40 mm, the paper tape was started to be pulled at 90°, and the positive electrode mixture layer adhered to the surface of the double-sided adhesive tape was pulled away from a current collector until the test was finished;
(7) Test data was saved according to the prompt of the software, i.e., the adhesion force data between the positive electrode mixture layer and the current collector was obtained; after the test was completed, the sample was taken out and the instrument was turned off.

Test for Brittleness of Electrode Plate

A cold-pressed positive electrode plate prepared in each of Embodiments and Comparative Embodiments was dried in a fume hood at 25° C. and 40% RH (relative humidity) for 4 hours, and the dried positive electrode plate was taken out. The positive electrode plate was then cut into a 4 cm×25 cm sample, which was pre-folded in half along the longitudinal direction of the sample, the pre-folded test film plate was placed on the test bench plane, a 2 kg cylinder was used to roll on the pre-folded sample twice, the sample was folded reversely along a longitudinal crease, the electrode plate was spread and observed facing the light. If the electrode plate was fractured after being folded in half, or the light transmission part is connected into a line, it is defined as serious; if the electrode plate was point-like transparent after being folded in half, it is defined as slight; if the electrode plate was not transparent or fractured after being folded in half, it is defined as none.

Test for Roughness of Current Collector

Test for Roughness of Surface of Current Collector in First Region
(1) A discharged lithium-ion battery to be tested was disassembled, then a positive electrode plate was taken out, soaked in DMO for 30 min to remove an electrolytic solution and by-products on the surface of the positive electrode plate, and then dried in a fume hood at 25° C. for 4 hours, and the dried positive electrode plate was taken out and soaked in N-methyl pyrrolidone (NMP) for 30 min;
(2) The positive electrode plate treated in step (1) was laid flat on a glass plate, a positive electrode mixture layer was wiped off with a dust-free paper (Clearoom wipe-0609), and the positive electrode plate was washed using NMP until no black or grey lumps with a diameter greater than 500 μm adhere, and then naturally dried;
(3) A 50 mm×50 mm to-be-tested sample was cut, and laid flat under the lens of a high-power microscope (model VK-S100), a lens with 10× magnification a lens with magnification was selected to adjust the focal length until the interface was clear; in the form of 3D scanning, the microscope operation interface was opened, the upper and lower limits of 3D scanning were adjusted, and the “3D scanning” button was clicked to perform 3D scanning; after the 3D scanning was completed, the roughness was automatically calculated, i.e., the roughness of the surface of the current collector in the first region.

Test for Roughness of Surface of Current Collector in Second Region (Foil-Free Region)

A current collector in a foil-free region was directly cut into a 50 mm×50 mm sample to be tested, and the sample to be tested was laid flat under the lens of a high-power microscope (model VK-S100), and a 10× magnification lens was selected to adjust the focal length until the interface was clear; in the form of 3D scanning, the microscope operation interface was opened, the upper and lower limits of 3D scanning were adjusted, and the “3D scanning” button was clicked to perform 3D scanning; after the 3D scanning was completed, the roughness was automatically calculated, namely, the roughness of the surface of the current collector in the second region.

Test for Tensile Strength of Current Collector:

Test for Tensile Strength of Current Collector of First Region
(1) A discharged lithium-ion battery to be tested was disassembled, then a positive electrode plate was taken out, soaked in DMO for 30 min to remove an electrolytic solution and by-products on the surface of the positive electrode plate, and then dried in a fume hood at 25° C. for 4 hours, and the dried positive electrode plate was taken out and soaked in N-methyl pyrrolidone (NMP) for 30 min;
(2) The positive electrode plate treated in step (1) was laid flat on a glass plate, a positive electrode mixture layer was wiped off with a dust-free paper (Clearoom wipe-0609), and the positive electrode plate was washed with NMP until no black or grey lumps with a diameter greater than 500 μm adhere, and then naturally dried to obtain the sample to be tested;
(3) The sample to be tested was taken and from same, a test sample with the width of 15 mm and the length of 100 mm was cut using a blade; then the upper and lower ends of the cut test sample were fixed on clamps of a tensile machine, with a distance of 50 mm remained between the clamps; an operating system of the tensile machine was used to move the upper clamp upwards at the speed of 5 mm/min until the test sample was fractured; the tensile force F was measured, and the tensile strength was obtained through F and the width L and thickness H of the test sample according to the formula δ=F/(L×H). The width and thickness of the test sample could be measured by a micrometer.

Test for Tensile Strength of Current Collector of Second Region (Foil-Free Region)

A current collector in a foil-free region was directly cut into a 50 mm×50 mm sample to be tested; the sample to be tested was taken and from same, and a test sample with the width of 15 mm and the length of 100 mm was cut using a blade; then the upper and lower ends of the cut test sample were fixed on clamps of a tensile machine, with a distance of 50 mm remained between the clamps; an operating system of the tensile machine was used to move the upper clamp upwards at the speed of 5 mm/min until the test sample was factured; the tensile force F was measured, and the tensile strength was calculated through F and the width L and thickness H of the test sample according to the expression δ=F/(L×H). The width and thickness of the test sample could be measured by a micrometer.

Test for Compacted Density of Positive Electrode Mixture Layer

Compacted density of positive electrode mixture layer=mass of positive electrode active material layer per unit area (g/mm2)/thickness of positive electrode mixture layer (mm). A discharged lithium-ion battery to be tested was disassembled, then a positive electrode plate was taken out, soaked in DMO (dimethyl oxalate) for 30 min to remove an electrolytic solution and by-products on the surface of the positive electrode plate, and then dried in a fume hood for 4 hours at a temperature of 25° C., the dried positive electrode plate was taken out, the thickness of the positive electrode mixture layer in the positive electrode plate was measured with a ten-thousandth micrometer, the positive electrode plate was then die-cut to obtain a small circular plate with an area of 1540.25 mm2, the mass m1 of the small circular plate was weighed with a balance, and then the mass m2 of the current collector of the small circular plate with the same area was weighed, and the mass of the positive electrode active material through calculation was obtained as: m1−m2, and then the compacted density of the positive electrode mixture layer was calculated according to the above formula.

Measurement of Weight Average Molecular Weight and Number Average Molecular Weight of Binder

For the test on molecular weight and molecular weight distribution, refer to GB/T 21863-2008 Gel permeation chromatography, use ultra-high performance polymer chromatograph: ACQUITY APC; detector: ACOUITY differential refractometer detector. The test steps were as follows: (1) Startup preheating: a chromatographic column and a tubing were installed, a console, a test power supply, etc. were turned on in sequence, and test software Empower was opened; (2) parameters were set, i.e., sampling volume: 0 μL to 50 μL (depending on sample concentration); pump flow rate: 0.2 mL/min; mobile phase: NMP solution of 30 mol/L LiBr; sealing cleaning solution: isopropanol; pre-column: PL gel 10 um MiniMIX-B Guard (Size: 50 mm×4.6 mm×2); analytical phase: PL gel 10 um MiniMIX-B (Size: 250 mm×4.6 mm); standard: a polystyrene kit; run time: 30 min; detector: ACOUITY differential refractive index (RI) detector; column oven temperature: 90° C.; detector temperature: 55° C. (3) Sample Testing: a. Preparation of standard and test samples: respectively weighing 0.002 g to 0.004 g of standard sample/test sample and adding 2 mL of a mobile phase liquid to prepare a 0.1% to 0.5% mixed standard, and place same in a refrigerator for >8 h; b. Test of standard solution/sample: editing a sample group to be tested and selecting an established sample group method; after a baseline was stable, clicking a running queue to start testing the sample; (4) data processing: according to the relationship between retention time and molecular weight, establishing a calibration curve using a chemical workstation, performing integral quantitation on a sample spectrum, and the chemical workstation automatically generating the results of molecular weight and molecular weight distribution.

Test of Swelling Rate of Binder

In a fume hood, a certain mass of a binder sample was taken, weighed to obtain m1, immersed in an electrolytic solution (the electrolytic solution was a mixture of EC and DMC according to the mass ratio of 1:1), and kept at 85° C. for 6 hours; after finishing, a residual liquid on the sample surface was absorbed using a dust-free paper (Clearoom wipe-0609), and weighed to obtain m2; the swelling rate of binder sample=(m2−m1)/m1×100%.

Test for Dv50 and Dv10 of Positive Electrode Active Material

The Dv50 and Dv10 of a positive electrode active material were respectively tested using a laser particle sizer.

Test for 1.5 C Discharge Rate Performance

At 25° C., a formed lithium-ion battery was charged to 4.45 V at a constant current rate of 0.2 C, and then charged at a constant voltage until the current was less than or equal to 0.05 C, and then allowed to stand for 30 minutes, and then discharged to 3.0 V at a constant current rate of 0.2 C, so that through test, a discharge capacity at a rate of 0.2 C of the lithium-ion battery can be obtained.

At 25° C., the lithium-ion battery was charged to 4.45 V at a constant current rate of 0.2 C, and then charged at a constant voltage until the current was less than or equal to 0.05 C, and then allowed to stand for 30 minutes, and then discharged to 3.0 V at a constant current rate of 1.5 C, so that through test, a discharge capacity at a rate of 1.5 C of the lithium-ion battery can be obtained.

Lithium-ion secondary battery 1.5 C rate discharge capacity retention (%)=1.5 C rate discharge capacity/0.2 C rate discharge capacity×100%.

### EMBODIMENT 1

<1-1. Preparation of Positive Electrode Plate>

<1-1-1. Preparation of Binder>

A reaction kettle with a volume of 25 L was vacuumized. After nitrogen was drawn to replace oxygen, firstly, 18 Kg of deionized water, 200 g of a sodium perfluorooctanoate solution with a mass concentration of 5%, and 80 g of paraffin (melting point 60° C.) were put into the reaction kettle. The stirring speed was adjusted to 140 rpm/min, and the temperature of the reaction kettle was raised to 90° C. Vinylidene fluoride monomer was added until the kettle pressure reached 5.0 MPa. 1.3 g of an initiator dioctyl peroxydicarbonate was added to start a polymerization reaction. Thereafter, the additional vinylidene fluoride monomer was added to maintain the kettle pressure at 5.0 MPa. Additional 0.01 g of the initiator was added at 10 min intervals in batches, and at 20%, 40%, 60% and 80% conversion rate, a chain transfer agent HFC-4310 was additionally added in four batches, with 5 g each batch. A total of 5 Kg of vinylidene fluoride monomer was added into the reaction. When the reaction proceeded until the pressure dropped to 4.0 MPa, the material was collected by venting, and the reaction time was 2 hours and 30 minutes. After centrifugation, washing and drying, a binder PVDF was obtained. The PVDF had a weight average molecular weight of 1100000 and a molecular weight distribution of Mw/Mn=2.15.

<1-1-2. Preparation of Positive Electrode Plate Containing Binder>

The positive electrode active material lithium cobaltate, acetylene black and the binder prepared were mixed in a mass ratio of 96:2:2, then NMP was added as a solvent to prepare a slurry with a solid content of 75%, which was stirred until uniform. The slurry was uniformly coated on one surface of an aluminium foil having a thickness of 9 μm, dried at 90° C., and cold-pressed to obtain a positive electrode plate having a positive electrode mixture layer with a single-sided thickness of 47 μm, and then the above steps were repeated on the other surface of the positive electrode plate to obtain a positive electrode plate having both sides coated with a positive electrode active material layer. The Dv50 of the positive electrode active material was 15.6 μm, the Dv10 of the positive electrode active material was 4.5 μm, Dv10/Dv50=0.37, and the compacted density of the positive electrode mixture layer was 4.18 g/mm3. The positive electrode plate was cut into a size of 74 mm×867 mm and a tab was welded thereto before use. The relevant preparation parameters and Sa1/Sa2, (P2−P1)/P2 of the positive electrode plate are shown in Tables 1 and 2.

<1-2. Preparation of Negative Electrode Plate>

The negative electrode active substance artificial graphite, styrene-butadiene rubber and sodium carboxymethyl cellulose were mixed in a mass ratio of 96:2:2, then deionized water was added as a solvent to prepare a slurry with a solid content of 70%, which was stirred until uniform. The slurry was uniformly coated on one surface of a copper foil having a thickness of 8 μm, dried at 110° C., and cold-pressed to obtain a negative electrode plate coated with a negative electrode active material layer on one side and having a negative electrode mixture layer with a thickness of 50 μm, and then the above coating steps were repeated on the other surface of the negative electrode plate to obtain a negative electrode plate coated with a negative electrode active material layer on both sides. The negative electrode plate was cut into a size of 74 mm×867 mm and a tab was welded thereto before use.

<1-3. Preparation of Separator>

A polyethylene (PE) porous polymeric film with a thickness of 15 μm was used as a separator.

<1-4. Preparation of Electrolytic Solution>

A non-aqueous organic solvent of ethylene carbonate (EC), propylene carbonate (PC) and diethyl carbonate (DEC) was mixed in a mass ratio of 1:1:1 in an environment having a water content of less than 10 ppm, and then lithium hexafluorophosphate (LiPF6) was added to the non-aqueous organic solvent to be dissolved and mixed uniformly to obtain an electrolytic solution, wherein the concentration of LiPF6 was 1.15 mol/L.

<1-5. Preparation of Lithium-Ion Battery>

The positive electrode plate, the separator and the negative electrode plate prepared above were stacked in sequence, so that the separator was located between the positive electrode plate and the negative electrode plate to play a role of separation, and the same were wound to obtain an electrode assembly. The electrode assembly was packed into an aluminium-plastic film packaging bag, and the water was removed at 80° C.; the prepared electrolytic solution was injected; and a lithium-ion battery was obtained through vacuum packaging, standing, formation, shaping and other procedures.

### EMBODIMENT 2

The contents were the same as Embodiment 1 except that in <Preparation of positive electrode plate>, the single-sided thickness of the positive electrode mixture layer was adjusted to be 46 μm, and the compacted density of the positive electrode mixture layer was adjusted to be 4.23 g/mm3. The Sa1/Sa2, (P2−P1)/P2 of the positive electrode plate are shown in Tables 1 and 2.

### EMBODIMENT 3

The contents were the same as Embodiment 1 except that in <Preparation of positive electrode plate>, the single-sided thickness of the positive electrode mixture layer was adjusted to be 45 μm, and the compacted density of the positive electrode mixture layer was adjusted to be 4.28 g/mm3. The Sa1/Sa2, (P2−P1)/P2 of the positive electrode plate are shown in Tables 1 and 2.

### EMBODIMENT 4

The contents were the same as Embodiment 1 except that in <Preparation of positive electrode plate>, the single-sided thickness of the positive electrode mixture layer was adjusted to be 54 μm, and the compacted density of the positive electrode mixture layer was adjusted to be 3 g/mm3. The Sa1/Sa2, (P2−P1)/P2 of the positive electrode plate are shown in Tables 1 and 2.

### EMBODIMENT 5

The contents were the same as Embodiment 1 except that in <Preparation of positive electrode plate>, the single-sided thickness of the positive electrode mixture layer was adjusted to be 52 μm, and the compacted density of the positive electrode mixture layer was adjusted to be 3.6 g/mm3. The Sa1/Sa2, (P2−P1)/P2 of the positive electrode plate are shown in Tables 1 and 2.

### EMBODIMENT 6

The contents were the same as Embodiment 1 except that in <Preparation of positive electrode plate>, the single-sided thickness of the positive electrode mixture layer was adjusted to be 43 μm, and the compacted density of the positive electrode mixture layer was adjusted to be 4.5 g/mm3. The Sa1/Sa2, (P2−P1)/P2 of the positive electrode plate are shown in Tables 1 and 2.

### EMBODIMENT 7

The contents were the same as Embodiment 1 except that in <Preparation of positive electrode plate>, the single-sided thickness of the positive electrode mixture layer was adjusted to be 44 μm, and the compacted density of the positive electrode mixture layer was adjusted to be 4.33 g/mm3. The Sa1/Sa2, (P2−P1)/P2 of the positive electrode plate are shown in Tables 1 and 2.

### EMBODIMENT 8

The contents were the same as Embodiment 2 except that in <Preparation of positive electrode plate>, the thickness of the current collector (aluminum foil) was adjusted to be 10 μm. The Sa1/Sa2, (P2−P1)/P2 of the positive electrode plate are shown in Tables 1 and 2.

### EMBODIMENT 9

The contents were the same as Embodiment 2 except that in <Preparation of positive electrode plate>, the thickness of the current collector was adjusted to be 11 μm. The Sa1/Sa2, (P2−P1)/P2 of the positive electrode plate are shown in Tables 1 and 2.

### EMBODIMENT 10

The contents were the same as Embodiment 2 except that in <Preparation of positive electrode plate>, the thickness of the aluminum foil was adjusted to be 12 μm. The Sa1/Sa2, (P2−P1)/P2 of the positive electrode plate are shown in Tables 1 and 2.

### EMBODIMENT 11

The contents were the same as Embodiment 2 except that in <Preparation of binder>, the weight average molecular weight of the binder was adjusted to be 1000000. The Sa1/Sa2, (P2−P1)/P2 of the positive electrode plate are shown in Tables 1 and 2.

### EMBODIMENT 12

The contents were the same as Embodiment 2 except that in <Preparation of binder>, the weight average molecular weight of the binder was adjusted to be 1200000. The Sa1/Sa2, (P2−P1)/P2 of the positive electrode plate are shown in Tables 1 and 2.

### EMBODIMENT 13

The contents were the same as Embodiment 2 except that in <Preparation of binder>, the weight average molecular weight of the binder was adjusted to be 1300000. The Sa1/Sa2, (P2−P1)/P2 of the positive electrode plate are shown in Tables 1 and 2.

### EMBODIMENT 14

The contents were the same as Embodiment 2 except that in <Preparation of binder>, the weight average molecular weight of the binder was adjusted to be 1400000. The Sa1/Sa2, (P2−P1)/P2 of the positive electrode plate are shown in Tables 1 and 2.

### EMBODIMENT 15

The contents were the same as Embodiment 2 except that in <Preparation of the positive electrode plate>, the mw/Mn of the binder was adjusted to be 1.9. The Sa1/Sa2, (P2−P1)/P2 of the positive electrode plate are shown in Tables 1 and 2.

### EMBODIMENT 16

The contents were the same as Embodiment 2 except that in <Preparation of binder>, the Mw/Mn of the binder was adjusted to be 2.3. The Sa1/Sa2, (P2−P1)/P2 of the positive electrode plate are shown in Tables 1 and 2.

### EMBODIMENT 17

The contents were the same as Embodiment 2 except that in <Preparation of binder>, the mw/Mn of the binder was adjusted to be 2. The Sa1/Sa2, (P2−P1)/P2 of the positive electrode plate are shown in Tables 1 and 2.

### EMBODIMENT 18

The contents were the same as Embodiment 2 except that in <Preparation of binder>, the Mw/Mn of the binder was adjusted to be 2.5. The Sa1/Sa2, (P2−P1)/P2 of the positive electrode plate are shown in Tables 1 and 2.

### EMBODIMENT 19

The contents were the same as Embodiment 2 except that in <Preparation of positive electrode plate>, the Dv50 of the positive electrode active material was adjusted to be 0.5 μm, the Dv10/Dv50 of the positive electrode active material was adjusted to be the single-sided thickness of the positive electrode mixture layer was adjusted to be 48 μm, and the compacted density of the positive electrode mixture layer was adjusted to be 4.1 g/mm3. The Sa1/Sa2, (P2−P1)/P2 of the positive electrode plate are shown in Tables 1 and 2.

### EMBODIMENT 20

The contents were the same as Embodiment 2 except that in <Preparation of positive electrode plate>, the Dv50 of the positive electrode active material was adjusted to be 35 μm, the Dv10/Dv50 of the positive electrode active material was adjusted to be 0.17, the single-sided thickness of the positive electrode mixture layer was adjusted to be 47 μm, and the compacted density of the positive electrode mixture layer was adjusted to be 4.15 g/mm3. The Sa1/Sa2, (P2−P1)/P2 of the positive electrode plate are shown in Tables 1 and 2.

### EMBODIMENT 21

The contents were the same as Embodiment 2 except that in <Preparation of positive electrode plate>, the Dv50 of the positive electrode active material was adjusted to be 23 μm, the Dv10/Dv50 of the positive electrode active material was adjusted to be 0.25, the single-sided thickness of the positive electrode mixture layer was adjusted to be 47 μm, and the compacted density of the positive electrode mixture layer was adjusted to be 4.15 g/mm3. The Sa1/Sa2, (P2−P1)/P2 of the positive electrode plate are shown in Tables 1 and 2.

### EMBODIMENT 22

The contents were the same as Embodiment 2 except that in <Preparation of positive electrode plate>, the Dv50 of the positive electrode active material was adjusted to be 6.5 μm, the Dv10/Dv50 of the positive electrode active material was adjusted to be 0.45, the single-sided thickness of the positive electrode mixture layer was adjusted to be 49 μm, and the compacted density of the positive electrode mixture layer was adjusted to be 4.05 g/mm3. The Sa1/Sa2, (P2−P1)/P2 of the positive electrode plate are shown in Tables 1 and 2.

### EMBODIMENT 23

The contents were the same as Embodiment 2 except that in <Preparation of binder>, the weight average molecular weight of the binder was adjusted to be 1600000, and the compacted density of the positive electrode mixture layer was adjusted to be 4.18 g/mm3. The Sa1/Sa2, (P2−P1)/P2 of the positive electrode plate are shown in Tables 1 and 2.

### EMBODIMENT 24

The contents were the same as Embodiment 2 except that in <Preparation of binder>, the weight average molecular weight of the binder was adjusted to be 800000, and the compacted density of the positive electrode mixture layer was adjusted to be 4.18 g/mm3. The Sa1/Sa2, (P2−P1)/P2 of the positive electrode plate are shown in Tables 1 and 2.

### EMBODIMENT 25

The contents were the same as Embodiment 2 except that in <Preparation of binder>, the Mw/Mn of the binder was adjusted to be 2.6 and the compacted density of the positive electrode mixture layer was adjusted to be 4.18 g/mm3. The Sa1/Sa2, (P2−P1)/P2 of the positive electrode plate are shown in Tables 1 and 2.

### EMBODIMENT 26

The contents were the same as Embodiment 2 except that in <Preparation of binder>, the mw/Mn of the binder was adjusted to be 1.8 and the compacted density of the positive electrode mixture layer was adjusted to be 4.18 g/mm3. The Sa1/Sa2, (P2−P1)/P2 of the positive electrode plate are shown in Tables 1 and 2.

### EMBODIMENT 27

The contents were the same as Embodiment 2 except that in <Preparation of positive electrode plate>, the Dv50 of the positive electrode active material was adjusted to be 38 μm, the Dv10/Dv50 of the positive electrode active material was adjusted to be 0.15, the single-sided thickness of the positive electrode mixture layer was adjusted to be 49 μm, and the compacted density of the positive electrode mixture layer was adjusted to be 4.05 g/mm3. The Sa1/Sa2, (P2−P1)/P2 of the positive electrode plate are shown in Tables 1 and 2.

### EMBODIMENT 28

The contents were the same as Embodiment 2 except that in <Preparation of positive electrode plate>, the Dv50 of the positive electrode active material was adjusted to be 0.2 μm, the Dv10/Dv50 of the positive electrode active material was adjusted to be 0.55, the single-sided thickness of the positive electrode mixture layer was adjusted to be 50 μm, and the compacted density of the positive electrode mixture layer was adjusted to be 4.00 g/mm3. The Sa1/Sa2, (P2−P1)/P2 of the positive electrode plate are shown in Tables 1 and 2.

### COMPARATIVE EMBODIMENT 1

The contents were the same as Embodiment 2 except that in <Preparation of positive electrode plate>, the single-sided thickness of the positive electrode mixture layer was adjusted to be 40.5 μm, and the compacted density of the positive electrode mixture layer was adjusted to be 4.6 g/mm3. The Sa1/Sa2, (P2−P1)/P2 of the positive electrode plate are shown in Tables 1 and 2.

### COMPARATIVE EMBODIMENT 2

The contents were the same as Embodiment 1 except that in <Preparation of binder>, the weight average molecular weight of the binder was adjusted to be 850,000, and the molecular weight distribution Mw/Mn was adjusted to be 1.8. The Sa1/Sa2, (P2−P1)/P2 of the positive electrode plate are shown in Tables 1 and 2.

### COMPARATIVE EMBODIMENT 3

The contents were the same as Embodiment 2 except that in <Preparation of binder>, the weight average molecular weight of the binder was adjusted to be 850000, and the molecular weight distribution Mw/Mn was adjusted to be 1.8. The Sa1/Sa2, (P2−P1)/P2 of the positive electrode plate are shown in Tables 1 and 2.

### COMPARATIVE EMBODIMENT 4

The contents were the same as Embodiment 2 except that in <Preparation of binder>, the weight average molecular weight of the binder was adjusted to be 950000, and the molecular weight distribution Mw/Mn was adjusted to be 1.7. The Sa1/Sa2, (P2−P1)/P2 of the positive electrode plate are shown in Tables 1 and 2.

### COMPARATIVE EMBODIMENT 5

The contents were the same as Embodiment 2 except that in <Preparation of binder>, the weight average molecular weight of the binder was adjusted to be 1,200,000, and the molecular weight distribution Mw/Mn was adjusted to be 2.6. The Sa1/Sa2, (P2−P1)/P2 of the positive electrode plate are shown in Tables 1 and 2.

### COMPARATIVE EMBODIMENT 6

The contents were the same as Embodiment 1 except that in <Preparation of positive electrode plate>, the Dv50 of the positive electrode active material was adjusted to be 0.2 μm, and the Dv10/Dv50 of the positive electrode active material was adjusted to be 0.70. The Sa₁/Sa₂, (P₂−P₁)/P₂ of the positive electrode plate are shown in Tables 1 and 2.

### COMPARATIVE EMBODIMENT 7

The contents were the same as Embodiment 2 except that in <Preparation of positive electrode plate>, the Dv50 of the positive electrode active material was adjusted to be 38 μm, and the Dv10/Dv50 of the positive electrode active material was adjusted to be 0.15. The Sa₁/Sa₂, (P₂−P₁)/P₂ of the positive electrode plate are shown in Tables 1 and 2.

The preparation parameters and test results of various embodiments and comparative embodiments are shown in Tables 1 and 2 below.

TABLE 1

| | | | | Swelling | Adhesion | | |
|---|---|---|---|---|---|---|---|
| | | | | rate (%) of | force (N/m) | | |
| | | | | the binder | between the | | |
| | | | | after being | positive | | |
| | | | | soaked in the | electrode | | |
| | | | | electrolytic | mixture | | |
| | | | | solution | layer and | | 1.5 C |
| | Sa₁ | Sa₂ | | for 6 h at | the current | | discharge |
| Serial No. | (μm) | (μm) | Sa₁/Sa₂ | 85° C. | collector | Brittleness | rate (%) |
| Embodiment 1 | 1 | 0.1 | 10 | 19.98 | 19.8 | none | 95.2 |
| Embodiment 2 | 1.2 | 0.1 | 12 | 19.98 | 19.4 | none | 94.3 |
| Embodiment 3 | 1.4 | 0.1 | 14 | 19.98 | 18.4 | none | 93.5 |
| Embodiment 4 | 0.15 | 0.1 | 1.5 | 19.98 | 14.5 | none | 88.70 |
| Embodiment 5 | 0.2 | 0.1 | 2 | 19.98 | 17.5 | none | 89.90 |
| Embodiment 6 | 2 | 0.1 | 20 | 19.98 | 18.4 | slight | 85.80 |
| Embodiment 7 | 1.5 | 0.1 | 15 | 19.98 | 18.1 | slight | 91.30 |
| Embodiment 8 | 1.15 | 0.1 | 11.5 | 19.98 | 19.8 | none | 94.10 |
| Embodiment 9 | 1 | 0.1 | 10 | 19.98 | 20.3 | none | 93.70 |
| Embodiment 10 | 1.23 | 0.1 | 12.3 | 19.98 | 21.5 | none | 93.80 |
| Embodiment 11 | 0.98 | 0.1 | 9.8 | 21.03 | 18.2 | none | 91.60 |
| Embodiment 12 | 1.1 | 0.1 | 11 | 20.62 | 19.9 | none | 91.50 |
| Embodiment 13 | 1.33 | 0.1 | 13.3 | 21.55 | 20 | none | 91.70 |
| Embodiment 14 | 1.4 | 0.1 | 14 | 23.03 | 20.6 | none | 91.80 |
| Embodiment 15 | 1.4 | 0.1 | 14 | 21.36 | 18.8 | none | 90.10 |
| Embodiment 16 | 1.3 | 0.1 | 13 | 22.35 | 17.4 | none | 90.30 |
| Embodiment 17 | 1.5 | 0.1 | 15 | 20.67 | 18.5 | none | 92.8 |
| Embodiment 18 | 1.4 | 0.1 | 14 | 19.98 | 15.5 | slight | 87.60 |
| Embodiment 19 | 1.0 | 0.1 | 10 | 19.98 | 25 | slight | 91.80 |
| Embodiment 20 | 2.0 | 0.1 | 20 | 19.98 | 13.5 | slight | 87.20 |
| Embodiment 21 | 1.6 | 0.1 | 16 | 19.98 | 14.6 | none | 88.90 |
| Embodiment 22 | 1.4 | 0.1 | 14 | 19.98 | 15.8 | none | 89.50 |
| Embodiment 23 | 1.8 | 0.1 | 18 | 24.03 | 21.3 | none | 90.10 |
| Embodiment 24 | 0.8 | 0.1 | 8 | 17.03 | 12.2 | none | 90.30 |
| Embodiment 25 | 1.8 | 0.1 | 18 | 21.98 | 17.1 | none | 89.40 |
| Embodiment 26 | 1.7 | 0.1 | 17 | 23.00 | 19.3 | none | 89.70 |
| Embodiment 27 | 1.9 | 0.1 | 19 | 19.98 | 12.5 | slight | 86.10 |
| Embodiment 28 | 1.55 | 0.1 | 15.5 | 19.98 | 13.1 | slight | 91.40 |
| Comparative | 2.5 | 0.1 | 25 | 19.98 | 18.7 | serious | 78.10 |
| embodiment 1 | | | | | | | |
| Comparative | 2.2 | 0.1 | 22 | 17.50 | 18.5 | slight | 84.6 |
| Embodiment 2 | | | | | | | |
| Comparative | 2.5 | 0.1 | 25 | 17.50 | 18.8 | serious | 79.50 |
| Embodiment 3 | | | | | | | |
| Comparative | 2.3 | 0.1 | 23 | 18.90 | 17.3 | serious | 80.60 |
| Embodiment 4 | | | | | | | |
| Comparative | 2.4 | 0.1 | 24 | 20.62 | 14.2 | serious | 81.10 |
| Embodiment 5 | | | | | | | |
| Comparative | 2.3 | 0.1 | 23 | 19.98 | 18.3 | serious | 84.20 |
| Embodiment 6 | | | | | | | |
| Comparative | 2.2 | 0.1 | 22 | 19.98 | 18.1 | serious | 76.70 |
| Embodiment 7 | | | | | | | |

TABLE 2

| | | | | | Single-sided | | |
|---|---|---|---|---|---|---|---|
| | | | Dv50 of | | thickness of | | |
| | Weight | | positive | Dv10/Dv50 | positive | | |
| | average | | electrode | of positive | electrode | Thickness | |
| | molecular | | active | electrode | mixture | of current | Compacted |
| | weight (ten | | material | active | layer | collector | density |
| Serial No. | thousand) | Mw/Mn | (μm) | material | (μm) | (μm) | (g/mm3) |
| Embodiment 1 | 110 | 2.15 | 15.6 | 0.37 | 47 | 9 | 4.18 |
| Embodiment 2 | 110 | 2.15 | 15.6 | 0.37 | 46 | 9 | 4.23 |
| Embodiment 3 | 110 | 2.15 | 15.6 | 0.37 | 45 | 9 | 4.28 |
| Embodiment 4 | 110 | 2.15 | 15.6 | 0.37 | 54 | 9 | 3 |
| Embodiment 5 | 110 | 2.15 | 15.6 | 0.37 | 52 | 9 | 3.6 |
| Embodiment 6 | 110 | 2.15 | 15.6 | 0.37 | 43 | 9 | 4.5 |
| Embodiment 7 | 110 | 2.15 | 15.6 | 0.37 | 44 | 9 | 4.33 |
| Embodiment 8 | 110 | 2.15 | 15.6 | 0.37 | 46 | 10 | 4.23 |
| Embodiment 9 | 110 | 2.15 | 15.6 | 0.37 | 46 | 11 | 4.23 |
| Embodiment 10 | 110 | 2.15 | 15.6 | 0.37 | 46 | 12 | 4.23 |
| Embodiment 11 | 100 | 2.15 | 15.6 | 0.37 | 46 | 9 | 4.23 |
| Embodiment 12 | 120 | 2.15 | 15.6 | 0.37 | 46 | 9 | 4.23 |
| Embodiment 13 | 130 | 2.15 | 15.6 | 0.37 | 46 | 9 | 4.23 |
| Embodiment 14 | 140 | 2.15 | 15.6 | 0.37 | 46 | 9 | 4.23 |
| Embodiment 15 | 110 | 1.9 | 15.6 | 0.37 | 46 | 9 | 4.23 |
| Embodiment 16 | 110 | 2.3 | 15.6 | 0.37 | 46 | 9 | 4.23 |
| Embodiment 17 | 110 | 2 | 15.6 | 0.37 | 46 | 9 | 4.23 |
| Embodiment 18 | 110 | 2.5 | 15.6 | 0.37 | 46 | 9 | 4.23 |
| Embodiment 19 | 110 | 2.15 | 0.5 | 0.60 | 48 | 9 | 4.1 |
| Embodiment 20 | 110 | 2.15 | 35 | 0.17 | 47 | 9 | 4.15 |
| Embodiment 21 | 110 | 2.15 | 23 | 0.25 | 47 | 9 | 4.15 |
| Embodiment 22 | 110 | 2.15 | 6.5 | 0.45 | 49 | 9 | 4.05 |
| Embodiment 23 | 160 | 2.15 | 15.6 | 0.37 | 47 | 9 | 4.18 |
| Embodiment 24 | 80 | 2.15 | 15.6 | 0.37 | 47 | 9 | 4.18 |
| Embodiment 25 | 110 | 2.6 | 15.6 | 0.37 | 47 | 9 | 4.18 |
| Embodiment 26 | 110 | 1.8 | 15.6 | 0.37 | 47 | 9 | 4.18 |
| Embodiment 27 | 110 | 2.15 | 38 | 0.15 | 49 | 9 | 4.05 |
| Embodiment 28 | 110 | 2.15 | 0.2 | 0.55 | 50 | 9 | 4.00 |
| Comparative | 110 | 2.15 | 15.6 | 0.37 | 40.5 | 9 | 4.6 |
| Embodiment 1 | | | | | | | |
| Comparative | 85 | 1.8 | 15.6 | 0.37 | 47 | 9 | 4.18 |
| Embodiment 2 | | | | | | | |
| Comparative | 85 | 1.8 | 15.6 | 0.37 | 46 | 9 | 4.23 |
| Embodiment 3 | | | | | | | |
| Comparative | 95 | 1.7 | 15.6 | 0.37 | 46 | 9 | 4.23 |
| Embodiment 4 | | | | | | | |
| Comparative | 120 | 2.6 | 15.6 | 0.37 | 46 | 9 | 4.23 |
| Embodiment 5 | | | | | | | |
| Comparative | 110 | 2.15 | 0.2 | 0.70 | 47 | 9 | 4.18 |
| Embodiment 6 | | | | | | | |
| Comparative | 110 | 2.15 | 38 | 0.15 | 46 | 9 | 4.23 |
| Embodiment 7 | | | | | | | |

| | | | | | Adhesion | | |
|---|---|---|---|---|---|---|---|
| | | | | Swelling | force (N/m) | | |
| | | | | rate (%) of | between the | | |
| | | | | the binder | positive | | |
| | | | | after being | electrode | | |
| | | | | soaked in the | mixture | | 1.5 C |
| | | | (P₂ − | electrolytic | layer and | | discharge |
| | P1 | P2 | P₁)/P₂ | solution for | the current | | rate |
| Serial No. | (MPa) | (MPa) | (%) | 6 h at 85° C. | collector | Brittleness | (%) |
| Embodiment 1 | 210 | 256 | 17.97 | 19.98 | 19.8 | none | 95.2 |
| Embodiment 2 | 203 | 256 | 20.7 | 19.98 | 19.4 | none | 94.3 |
| Embodiment 3 | 202 | 256 | 21.1 | 19.98 | 18.4 | none | 93.5 |
| Embodiment 4 | 220 | 256 | 14.06 | 19.98 | 14.5 | none | 88.70 |
| Embodiment 5 | 215 | 256 | 16.02 | 19.98 | 17.5 | none | 89.90 |
| Embodiment 6 | 192 | 256 | 21.7 | 19.98 | 18.4 | slight | 85.80 |
| Embodiment 7 | 200 | 256 | 21.88 | 19.98 | 18.1 | slight | 91.30 |
| Embodiment 8 | 210 | 258 | 18.6 | 19.98 | 19.8 | none | 94.10 |
| Embodiment 9 | 205 | 260 | 21.15 | 19.98 | 20.3 | none | 93.70 |
| Embodiment 10 | 208 | 265 | 21.51 | 19.98 | 21.5 | none | 93.80 |
| Embodiment 11 | 207 | 256 | 19.14 | 21.03 | 18.2 | none | 91.60 |
| Embodiment 12 | 205 | 256 | 19.92 | 20.62 | 19.9 | none | 91.50 |
| Embodiment 13 | 202 | 256 | 21.09 | 21.55 | 20 | none | 91.70 |
| Embodiment 14 | 200 | 256 | 21.88 | 23.03 | 20.6 | none | 91.80 |
| Embodiment 15 | 207 | 256 | 19.14 | 21.36 | 18.8 | none | 90.10 |
| Embodiment 16 | 208 | 256 | 18.75 | 22.35 | 17.4 | none | 90.30 |
| Embodiment 17 | 201 | 256 | 21.48 | 20.67 | 18.5 | none | 92.8 |
| Embodiment 18 | 200 | 256 | 21.88 | 19.98 | 15.5 | slight | 87.60 |
| Embodiment 19 | 220 | 256 | 14.06 | 19.98 | 25 | slight | 91.80 |
| Embodiment 20 | 205 | 256 | 19.92 | 19.98 | 13.5 | slight | 87.20 |
| Embodiment 21 | 207 | 256 | 19.14 | 19.98 | 14.6 | none | 88.90 |
| Embodiment 22 | 208 | 256 | 18.75 | 19.98 | 15.8 | none | 89.50 |
| Embodiment 23 | 199 | 256 | 22.27 | 24.03 | 21.3 | none | 90.10 |
| Embodiment 24 | 208 | 256 | 18.75 | 17.03 | 12.2 | none | 90.30 |
| Embodiment 25 | 200 | 256 | 21.88 | 21.98 | 17.1 | none | 89.40 |
| Embodiment 26 | 203 | 256 | 20.70 | 23.00 | 19.3 | none | 89.70 |
| Embodiment 27 | 206 | 256 | 19.53 | 19.98 | 12.5 | slight | 86.10 |
| Embodiment 28 | 207 | 256 | 19.14 | 19.98 | 13.1 | slight | 91.40 |
| Comparative | 181 | 256 | 29.30 | 19.98 | 18.7 | serious | 78.10 |
| Embodiment 1 | | | | | | | |
| Comparative | 190 | 256 | 25.78 | 17.50 | 18.5 | slight | 84.6 |
| Embodiment 2 | | | | | | | |
| Comparative | 185 | 256 | 27.73 | 17.50 | 18.8 | serious | 79.50 |
| Embodiment 3 | | | | | | | |
| Comparative | 194 | 256 | 24.22 | 18.90 | 17.3 | serious | 80.60 |
| Embodiment 4 | | | | | | | |
| Comparative | 188 | 256 | 26.56 | 20.62 | 14.2 | serious | 81.10 |
| Embodiment 5 | | | | | | | |
| Comparative | 192 | 256 | 25.00 | 19.98 | 18.3 | serious | 84.20 |
| Embodiment 6 | | | | | | | |
| Comparative | 188 | 256 | 26.56 | 19.98 | 18.1 | serious | 76.70 |
| Embodiment 7 | | | | | | | |

As can be seen from Embodiments 1 to 28 and Comparative Embodiments 1 to 7, controlling Sa₁/Sa₂ within the scope of the present application can significantly solve the problem of brittle fracture of the positive electrode plate, and improve the adhesion force between the positive electrode mixture layer and the current collector, and the rate performance of the lithium-ion battery.

As can be seen from Embodiments 1 to 7 and Comparative Embodiment 1, the positive electrode mixture layer having the compacted density of the present application can significantly solve the problem of brittle fracture of the positive electrode plate, and improve the adhesion force between the positive electrode mixture layer and the current collector, and the rate performance of the lithium-ion battery.

The weight average molecular weight and molecular weight distribution of the binder, and the Dv50 of the positive electrode active material also generally have an effect on the performance of the lithium-ion battery, and it can be seen from Embodiments 11 to 14 and Embodiments 23 and 24 that the rate performance of the lithium-ion battery can be further improved by controlling the weight average molecular weight of the binder within the scope of the present application; it can be seen from Embodiments 15 to 18 and Embodiments 25 and 26 that the rate performance of the lithium-ion battery can be further improved by controlling the molecular weight distribution Mw/Mn of the binder within the scope of the present application; it can be seen from Embodiments 19 to 22 and Embodiments 27 and 28 that by controlling the Dv50 of the positive electrode active material within the scope of the present application, the problem of brittle fracture of the positive electrode plate can be further solved, and the adhesion force between the positive electrode mixture layer and the current collector and the rate performance of the lithium-ion battery can be improved.

The thickness of the positive electrode current collector also generally affects the performance of the lithium-ion battery, and it can be seen from Embodiments 7 to 10 that, as long as the thickness of the positive electrode current collector is within the scope of the present application, a lithium-ion battery having excellent brittleness, excellent binding performance between the positive electrode mixture layer and the current collector, and excellent rate performance can be obtained.

It can also be seen from Embodiments 1 to 28 that the lithium-ion battery of the present application has excellent brittleness and rate performance, and the binder in the positive electrode mixture layer thereof also has excellent electrolytic solution swelling resistance.

In conclusion, the positive electrode plate of the present application has a higher flexibility and thus has a higher compacted density, which can significantly solve the problem of brittle fracture caused by the high compacted density and improve the rate performance of the lithium-ion battery.

The above description is only the preferred embodiment of the present application and is not be used to limit the present application. Any modifications, equivalent replacements, improvements, etc. made within the spirit and principle of the present application are to be included within the scope of protection of the present application.

What is claimed is:

1. An electrochemical device, comprising a positive electrode comprising a current collector and a positive electrode mixture layer provided on at least one surface of the current collector; the current collector comprising a first region and a second region, the first region being provided with the positive electrode mixture layer, the second region being a foil-free region of the positive electrode; the positive electrode mixture layer comprising a positive electrode active material and a binder; wherein 1≤Sa₁/Sa₂≤20,
Sa₁ is a roughness of a surface of the current collector in the first region and Sa₂ is a roughness of a surface of the current collector in the second region.

2. The electrochemical device according to claim 1, wherein 0% ≤(P₂−P₁)/P₂≤22%,
P₁is a strength of the current collector in the first region and P₂ is a strength of the current collector in the second region.

3. The electrochemical device according to claim 1, wherein a compacted density of the positive electrode mixture layer is 3.0 g/mm³ to 4.5 g/mm³.

4. The electrochemical device according to claim 1, wherein the binder comprises polyvinylidene fluoride.

5. The electrochemical device according to claim 1, wherein a weight average molecular weight of the binder is 1,000,000 to 1,400,000.

6. The electrochemical device according to claim 1, wherein 1.9≤Mw/Mn≤2.5,
Mw represents a weight average molecular weight of the binder and Mn represents a number average molecular weight of the binder.

7. The electrochemical device according to claim 1, wherein the binder has a swelling ratio of 15% to 25% after being soaked in an electrolytic solution at 85° C. for 6 hours.

8. The electrochemical device according to claim 1, wherein an adhesion force between the positive electrode mixture layer and the current collector is 15 N/m to 35 N/m.

9. The electrochemical device according to claim 1, wherein a Dv50 of the positive electrode active material is 0.5 μm to 35 μm.

10. The electrochemical device according to claim 1, wherein a relationship between Dv10 and Dv50 of the positive electrode active material satisfies: 0.25≤Dv10/Dv50≤0.5.

11. The electrochemical device according to claim 1, wherein the positive electrode satisfies at least one of the following characteristics:
1) a compacted density of the positive electrode mixture layer is 4.0 g/mm³ to 4.3 g/mm³;
2) a thickness of the positive electrode mixture layer is 40.5 μm to 55 μm;
3) a Dv50 of the positive electrode active material in the positive electrode mixture layer is 10 μm to 25 μm;
4) a relationship between Dv10 and Dv50 of the positive electrode active material in the positive electrode mixture layer satisfies: 0.33≤Dv10/Dv50≤0.45; or
5) a thickness of the current collector is 7 μm to 20 μm.

12. An electronic device comprising an electrochemical device, the electrochemical device comprises a positive electrode comprising a current collector and a positive electrode mixture layer provided on at least one surface of the current collector; the current collector comprising a first region and a second region, the first region being provided with the positive electrode mixture layer, the second region being a foil-free region of the positive electrode; the positive electrode mixture layer comprising a positive electrode active material and a binder;
wherein 1≤Sa₁/Sa₂≤20,
Sa₁ is a roughness of a surface of the current collector in the first region and Sa₂ is a roughness of the surface of a current collector in the second region.

13. The electronic device according to claim 12, wherein 0%≤(P₂−P₁)/P₂≤22%,
P₁ is a strength of the current collector in the first region and P₂ is a strength of the current collector in the second region.

14. The electronic device according to claim 12, wherein a compacted density of the positive electrode mixture layer is 3.0 g/mm³ to 4.5 g/mm³.

15. The electronic device according to claim 12, wherein the binder comprises polyvinylidene fluoride.

16. The electronic device according to claim 12, wherein a weight average molecular weight of the binder is 1,000,000 to 1,400,000.

17. The electronic device according to claim 12, wherein 1.9≤Mw/Mn≤2.5,
Mw represents a weight average molecular weight of the binder and Mn represents a number average molecular weight of the binder.

18. The electronic device according to claim 12, wherein the binder has a swelling ratio of 15% to 25% after being soaked in an electrolytic solution at 85° C. for 6 hours.

19. The electronic device according to claim 12, wherein an adhesion force between the positive electrode mixture layer and the current collector is 15 N/m to 35 N/m.

20. The electronic device according to claim 12, wherein a Dv50 of the positive electrode active material is 0.5 μm to 35 μm.
